(19) United States
(12) Patent Application Publication
(10) Pub. No.: US 2002/0183078 A1
(43) Pub. Date: Dec. 5, 2002

(54) Local-area communication system and ID card holder

(75) Inventor: Yoshihiro Hase, Koganei-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Communications Res. Lab. Ind. Admin. Inst., Koganei-shi (JP)

(21) Appl. No.: 10/132,394

(22) Filed: Apr. 26, 2002

(30) Foreign Application Priority Data
Apr. 27, 2001 (JP) 2001-131131
Apr. 14, 2002 (JP) 2002-114665

(51) Int. Cl. H04Q 7/20

(52) U.S. Cl. 455/458; 455/554; 455/558

(57) ABSTRACT

A local-area communication system includes a private branch exchange that controls links between outside lines and the local area; wireless base-stations distributed within the local system area, each connected to the exchange; a portable card terminal capable of long-range wireless communication with the wireless base-stations, the portable card terminal having stored therein a unique ID number and being capable of short-range wireless communication in the local area; auxiliary telephone terminals located within the local area capable of short-range wireless communication with the portable card terminal and which can send and receive speech signals, and a portable card terminal box that is connected to the exchange. The card box can recharge the card terminal and transmit the ID information to the exchange.

### BACKGROUND OF THE INVENTION

1. Field of the Invention

The present invention relates to a local-area communication system comprising a private branch exchange that controls links between outside lines and the local area, and wireless base-stations that are located within the local area and have a wired connection to the exchange, to thereby ensure communication with wireless terminals carried by people in the local area. The invention also relates to an ID card holder that enables wireless communication with specific group affiliations in the local area.

2. Description of the Prior Art

In recent years many offices are using local-area PHS systems for their internal telephone requirements. This type of local-area communication system is convenient since the internal phones can also be carried around by the users. Organizations are also using ID cards for various purposes including employee management and security. Specifically, each employee of a company or research institution or other such specific organization is assigned a unique ID number that is stored on an ID card.

However, because employees do not normally carry bags or briefcases or the like as they move around in their office environment, the internal phones are usually stuffed in a pocket or carried around in the hand, which is not so convenient. Also, although progress in integration technology enables terminals to be made smaller and lighter, there is a limit to this, since the phones must still be of a suitable shape and size to enable them to be used for telephone conversations. Thus, these phones are being asked to satisfy the contradictory requirements of being convenient to carry as well as being convenient to use. Achieving this is very difficult.

A conventional ID card has to be brought into contact with the sensor of a card reader in order to read the ID number, an operation that users are subjected to with great frequency. There are also sensor systems that can read ID card data contactlessly, but to do this the ID card has to be brought to within a few centimeters of the sensor, which may not always be so convenient.

An object of the present invention is to provide a local-area communication system that is convenient when used for telephone conversations and is convenient to carry.

Another object of the present invention is to provide an ID card holder that can read ID information and perform locking and unlocking operations without needing the ID card to be brought near or into contact with the reader sensor.

### SUMMARY OF THE INVENTION

To attain the above object, the present invention provides a local-area communication system, comprising a private branch exchange that controls links between outside lines and a local area, a plurality of wireless base-stations located within the local area, each base station having a wired connection to the private branch exchange, a portable card terminal capable of wireless long-range communication with the wireless base-stations, the portable card terminal having stored therein a unique ID number and being capable of short-range wireless communication in the local area and being of a size that is suitable for carrying, a plurality of auxiliary telephone terminals located within the local area capable of short-range wireless communication with the portable card terminal and having a speech transmission function and a speech reception function, and a portable card terminal holding means having a wired connection to the private branch exchange, the card holding means being able to recharge a portable card terminal accommodated therein and to transmit the ID number of the portable card terminal accommodated therein to the private branch exchange.

The private branch exchange can also include a cancel function for cancelling a communication request to the portable card terminal when having received from the card terminal holding means an ID number transmission signifying that the card terminal is in the card terminal holding means.

The portable card terminals can also be used for managing security within the system area by storing, as the ID number, information that can identify the user, and using short-range wireless communication to transmit the ID number.

The ID card holder of the invention comprises an ID card accommodation section that removably accommodates ID cards in each of which is stored in an electronically readable state ID information that constitutes unique identification information within a specific organization, wireless communication control means that performs wireless communication based on the ID information read from the ID cards in the ID card accommodation section, and electric power supply means that provides electric power to drive the wireless communication control means and for recharging.

The ID card holder has the ability to transmit the ID information to a wireless base-station of an access door control system when it has received an ID request from the base-station. Based on the ID information read from an ID card, the wireless communication control means can generate a determination that a call has been received, the determination being specifically for an ID number of the ID card, and when it receives an ID-information-based paging call from a wireless base-station of a paging system in a local area, it can provide notification that a paging call to a user's ID number has been received.

The wireless communication control means can transmit signals over the same distance as a wireless base-station of the paging system in the local area and, when a paging call to a user's ID number is received, transmits a page-received signal. Also, the wireless communication control means has the ability to perform short-range communication with internal telephone sets located within the local area and, when it receives an outside call to a user's ID number from a wireless base-station, can connect an internal telephone set within a communication area to the outside line by performing a reverse call based on the outside call.

Thus, users of the local-area communication system according to the present invention only need to carry a portable card-shaped terminal, which is very convenient to carry, and use an auxiliary terminal for telephone conversations.

Further features of the invention, its nature and various advantages will be more apparent from the accompanying drawings and following detailed description of the invention.

### BRIEF DESCRIPTION OF THE DRAWINGS

FIG. 1 shows the general configuration of an embodiment of the local-area communication system of the present invention.

FIG. 2 shows an embodiment of the ID card holder of the present invention applied to a door lock system.

FIG. 3 shows the general configuration of the ID card holder of the present invention applied to a local-area paging system.

### DESCRIPTION OF THE PREFERRED EMBODIMENT

First, the local-area communication system of the present invention will be described. This invention combines wireless long-range communication technology capable of general local-area coverage, and short-range wireless communication technology that is limited to relatively small areas, such as rooms and corridors, with interface control functions between the two being provided in a portable configuration. Making the interface control function section portable makes it possible to use for communication between local-area long-range wireless communication and short-range telephone handsets. Therefore, problem-free telephonic communication can be made possible within the local area by providing telephone sets throughout the area having the shape and size required for telephonic communication. Also, since the interface control function section does not need to be equipped with telephony functions, it can be the size and shape of a large name card or employee badge.

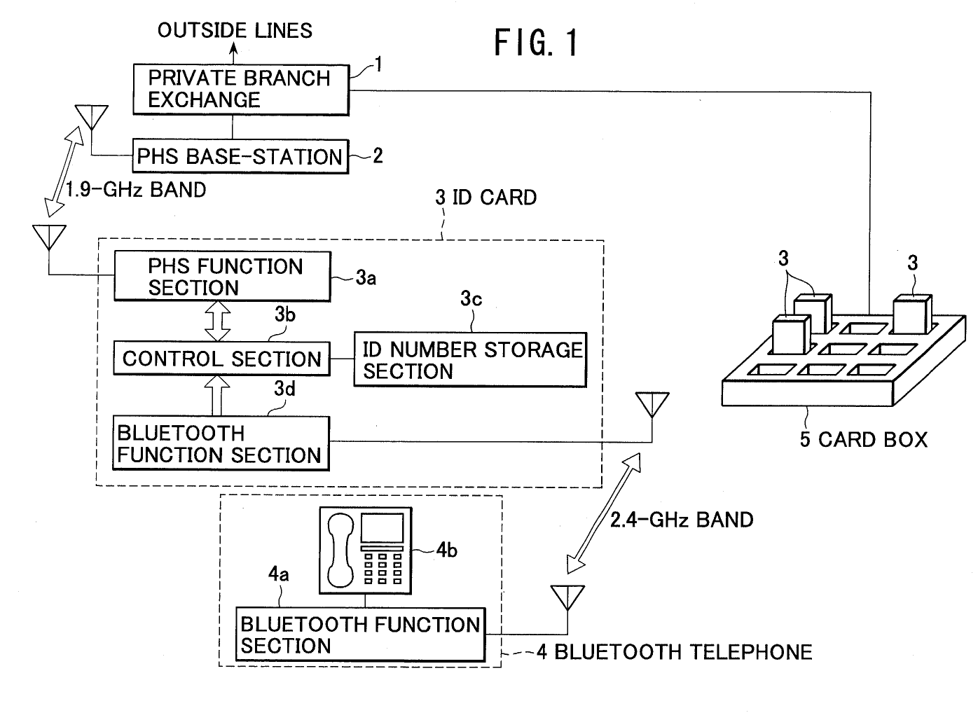

FIG. 1 shows the general configuration of an actual embodiment of the basic communication system applied to a local-area environment such as an office. The private branch exchange 1 controls connections and switching between outside lines and the local-area system, and is connected by wire to a plurality of local-area PHS base-stations 2 located at various points within the system area. The PHS base-stations 2 use the 1.9-GHz band to communicate wirelessly with each of the wireless ID cards 3 that constitute the portable card terminals. Each of the wireless ID cards 3 has a PHS function section 3a for communicating with the PHS base-stations 2, a control section 3b, and an ID number storage section 3c by which the card identifies itself when communicating with a PHS base-station 2. Each ID number thus stored is a unique identifier in the local-area system, and may be in any form that ensures this uniqueness in the range of system application. Thus, it is not limited to being a string of significant numbers such as an internal extension number, but may be a string of arbitrarily assigned 0 and 1 digits.

The wireless ID card 3 also has a Bluetooth function section 3d for effecting short-range wireless communication with the internal Bluetooth telephones 4, using the 2.4-GHz band. Each internal Bluetooth telephone 4 has a Bluetooth function section 4a for communicating with the wireless ID cards 3, and a telephone set 4b that has the send and receive functions of an ordinary telephone, for use by a wireless ID card 3 user.

The portable card terminal holding means for the wireless ID cards 3 is comprised by a card box 5, which recharges wireless ID cards 3 placed therein and transmits the ID numbers to the private branch exchange 1. This enables the private branch exchange 1 to cancel an external or internal request to communicate with an ID number assigned to an ID card 3 that is in the box 5. There are no particular limitations on the cancellation method; the private branch exchange 1 can, for example, be given the ability to send a voice message telling the caller that the call cannot be completed, and taking a message.

The stored ID number can also enable an ID card 3 to be used as a pass-key to doors in the local-area system. For example, an arrangement can be used whereby, once the security level required for access to each room has been set, the door only unlocks when it is determined that the received ID number transmitted by the Bluetooth function section 3d satisfies the security level requirement, thus enabling the system to be used to manage internal security.

A specific example of the operation of this local-area communication system will now be described. When there is an external telephone call, from the private branch exchange 1, the incoming signal goes via a connecting telephone line to a PHS base-station 2, which transmits the signal, which is received by the PHS function section 3a of an ID card 3. By means of the Bluetooth function section 3d, a nearby internal Bluetooth telephone 4 (which is never more than a few meters away) is identified and put into a standby state, so that when the signal from the PHS base-station 2 is received, the Bluetooth function enables short-range wireless communication with the telephone 4. When the control section 3b confirms signal reception by the PHS function section 3a, the Bluetooth function is used to call the nearby internal Bluetooth telephone 4, which rings. The holder of the ID card 3 can then answer the telephone and converse in the same way as when an ordinary internal telephone is used.

The internal Bluetooth telephone 4 can be provided with a display that, when the telephone 4 is put in the standby state, can be used to display the ID number of the ID card 3, or the name of the individual to which the ID number has been assigned, making it possible to tell whose call it is. The telephone 4 can also be provided with a loudspeaker via which a computer-generated voice can inform the person by name that there is a telephone call for him.

A person who wishes to make a call will pick up the handset of a telephone 4 and check that the telephone displays his name or ID number, signifying that he can use it as his telephone. Then he taps in the number he wants to call. If the ID card 3 is within the operating distance of the telephone set 4b, a Bluetooth connection should already have been established. However, there may be times when, because the user has forgotten to bring his wireless ID card, or the Bluetooth function does not work because of a fault or the like, or an internal Bluetooth telephone 4 is out of order, a telephonic communication link cannot be established. For such cases, it is desirable to be able to at least establish whether or not a call state is possible between an ID card 3 and an internal Bluetooth telephone 4.

After confirming that a call can be made and dialling the number on the telephone set 4b, using the Bluetooth function between the internal Bluetooth telephone 4 and the ID card 3, the ID card 3 is connected to the private branch exchange 1, using the local-area PHS function between the ID card 3 and the PHS base-station 2, thus making it possible to make a call from the internal telephone in the normal way.

Bluetooth, a short-range communication standard, is able to establish a temporary network between two or more wireless devices over a distance of up to several meters. If a person's ID card 3 enters a network in which there are a plurality of internal Bluetooth telephones 4, the control section 3b on the ID card 3 places just one of the internal Bluetooth telephones 4 into a standby state to use as his internal phone. This makes it possible to prevent a plurality of the Bluetooth telephones 4 all ringing at the same time when there is an incoming call. It is also possible to control the system so that a plurality of the phones ring, if that required. In such a case, the system could be controlled so that only telephones 4 that are off-hook when there is an incoming call can enter a telephone-conversation state.

A plurality of people carrying ID cards 3 who are near one Bluetooth telephone 4 can use the telephone 4 jointly. If there are two people, Person A and Person B, for example, and calls for both go to the same Bluetooth telephone 4, the telephone 4 can indicate which call is for which person by displaying the name or ID number, or by using a computer-generated voice to speak the name concerned. This allows the Bluetooth telephones 4 to be jointly utilized without any problem. It is also possible to store an individual ring tone or melody on each ID card 3 that can be used by the telephone 4 to indicate which person a call is for.

Using the ID card 3 as a general-purpose ID card will now be explained. The ID card 3 can be fabricated as a thin card slightly larger than a name card. There are commercial PHS devices for data communication that can be used in a CompactFlash® card slot of a notebook PC or PDA or the like. These extensively used devices measure about four centimeters wide by five centimeters long and five millimeters thick. Bluetooth products have only just started to appear on the market, but prototype production of modules about the same size is underway, so it will be readily possible to manufacture ID cards about the size of a large name card and about five millimeters thick.

A system could be configured in which the wireless ID cards 3 are used as ordinary ID cards to keep track of employees entering and leaving the office. If each card user has his own extension number, this could be readily achieved by storing the extension number on the card, which would correspond to the user's ID number or employee number. For example, when an employee enters the office, he could pick up his ID card 3 from an ID card box 5 located near the entrance, and return the ID card 3 to the box 5 when he leaves the office. If the box 5 is also equipped as a batter charger, this would allow the cards to be recharged overnight, and a computer used to keep track of when employees come in and leave could read the card ID information via the recharging adapter, making it possible to use the wireless ID cards like time-cards. The computer can be connected to the private branch exchange 1 to which the box 5 transmits the IDs of the ID cards 3 in the box 5, to make it possible to centralize management of ID card usage and employee work hours.

The system can also be used as a security management system. Again, this could be done by storing an individual ID number on each ID card 3, and using the cards to control the operation of doors or gates that provide access to rooms or areas subject to security control. In this case, a Bluetooth function would be incorporated into the electronic keys to the doors, so that as the user with the ID card 3 nears the door, the ID information can be read and the door unlocked. In addition to office building applications, such a system could be used to manage security in hotels, where the cards could not only be used as electronic keys to the guest rooms, but could also be used to operate telephones in the rooms or in the lobby, and to make payments in hotel restaurants and shops. Records of the transactions could be stored on the ID card, stored on a payment control server via a local-area PHS line connection, and so forth, speeding up the processing of guests' bills at checkout time.

In the case of the above-described embodiment, it was envisioned for use in a standard office building, university or research facility or the like, using an example of PHS distance-communication with a range of up to several hundred meters. In rooms and the like where a communication range of up to 10 meters is enough, a short-range Bluetooth-based personal wireless network system was used. However, the same effect can be obtained using various wireless technologies, according to the size of the local area concerned and the communication environment. For example, IMT-2000 can be applied instead of PHS.

Moreover, the above local-area communication system requires that each individual have a wireless ID card on which is stored an individual ID number. However, existing ID cards can be given the same type of functionality as a wireless ID card if the card information (organization administration number, extension telephone number and the like) is implemented in a readable form, even if the ID cards are configured separately from ID card holders with wireless communication capabilities. Below, details of an embodiment of the ID card holder according to this invention are described, with reference to the drawings.

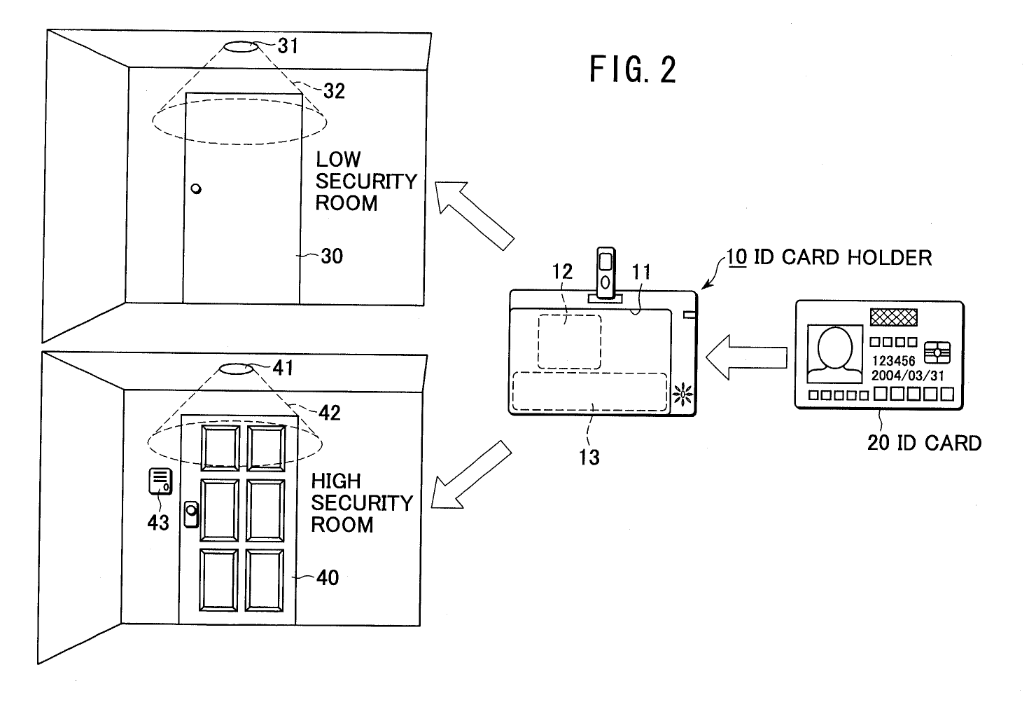

In this embodiment, the ID card holder is a plastic card holder that is worn on the chest and incorporates a short-range communication capability. The communication range of the system can be increased and a configuration used that enables the communication function to also be used to page telephones and the like. Specifically, as shown in FIG. 2, an ID card holder 10 into which can be removably inserted an ID card 20 containing unique ID information stored in an electronically readable form includes at least a holder clip 11, a wireless controller 12 that controls wireless communications based on ID information read from the ID card 20 in the card holder 11, and a rechargeable battery 13 that is the electrical power supply used to drive the wireless controller 12.

When a user inserts his ID card 20 (which is, for example, an employee ID in the form of a contact IC card an employee number and telephone number as ID information) into the ID card holder 10, it functions as that employee's wireless card terminal, and can therefore be applied to various systems that need to perform communication using the ID information. The ID card holder 10 is configured as a component separate from the ID card 20 that, for security reasons, cannot be easily re-issued, and functions as an ID wireless communication terminal by reading the ID information stored on the ID card 20. The ID card holder 10 itself can be manufactured as a general-purpose item, and so can be readily replaced by a new one if the communication function develops a malfunction.

There are limitations on the size, weight and electric power supply capacity of the battery 13 and communication capabilities (wireless controller 12, communication antenna, etc.) incorporated in the ID card holder 10. Therefore, when an ID card holder 10 is to be manufactured, which, with current technology, can be done at a relatively low cost, the communication functions are limited to confirming whether someone coming in is or is not an employee, whether the ID information will or will not allow access through security doors, and to paging by telephone, and other such functions.

FIG. 2 illustrates an application to a door locking system that controls access to a room. When a low security level is in effect for the door 30, the wireless base-station 31 forms an antenna beam area 32 (an area in which an ID request signal is sent to prompt transmission of ID information) in front of the door. When a person wearing an ID card holder 10 with an ID card 20 nears the door 30 and the ID card holder 10 enters the beam area 32, the ID card holder 10 receives an ID request signal from the wireless base-station 31. In response, the wireless controller 12 of the ID card holder 10 sends the ID information to the wireless base-station 31, and the door locking system determines whether the ID information meets the requirements of the security level setting, in which case the door 30 opens or unlocks automatically. If it is determined that the ID information does not allow access, the door remains locked.

Adding wireless transmission capability to the ID card 20 increases its convenience to the user by enabling ID information to be transmitted without the trouble of having to bring the ID card into contact with the sensor section of the door lock system for the ID information to be read, as is the case with a conventional IC card.

Similarly, when a high security level is in effect for the door 40 the wireless base-station 41 forms an antenna beam area 42 in front of the door. When an ID card holder 10 enters the beam area 42 the ID information is transmitted. The processing performed by the door locking system can be changed according to the security level involved. For example, instead of the door automatically opening or unlocking, when the person's ID permits access, permission to enter can be signified by a lamp beside the door changing from red to green, or the system can be set so that the person has to press a button 43 to open the door.

In the case of the ID card holder 10 applied to a door locking system described above, two-way short-range communication (Bluetooth, for example) is realized by means of the wireless controller 12. However, this system is not limited thereto, and the communication function realized by the wireless controller 12 can be changed to long-range or short-range, or one-way or two-way, depending on the system to which the wireless ID card holder of this invention is applied.

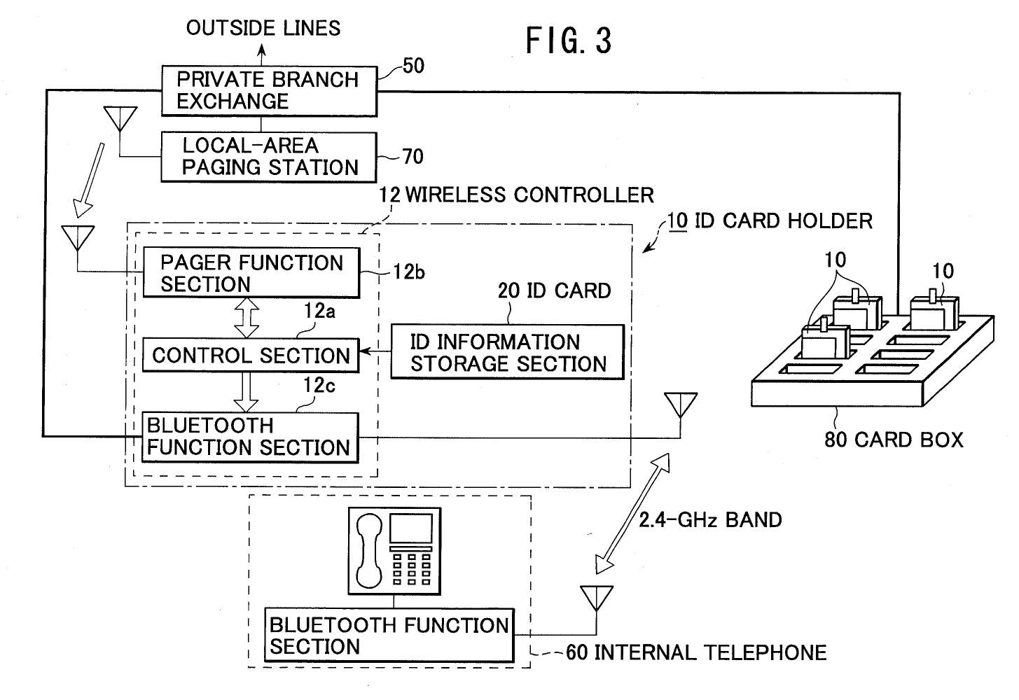

FIG. 3 illustrates an embodiment applied to a local-area paging system. A private branch exchange 50 that receives incoming calls from an outside line, internal telephone 60, and a local-area paging station (that pages ID card holders 10) 70 are connected together. Internal telephones 60, which are located throughout the local-area system and may be fixed telephones or portable types that are part of a local-area PHS system, incorporate a Bluetooth function section. The wireless controller 12 of the ID card holder 10 includes a control section 12a that generates an ID-received determination in respect of an ID based on ID information read from the ID information storage section of the ID card 20, a pager function section 12b for receiving paging signals from the local-area paging station 70, and a Bluetooth function section 12c that carries out two-way short-range communication with the internal telephone 60.

When there is an outside call for a Mr A, for example, the private branch exchange 50 pages Mr A by sending Mr A's ID number (or telephone number) to the local-area paging station 70. As a result, the ID card holder 10 uses a sound or a lamp to notify Mr A that a call has been received. Mr A then picks up a nearby internal telephone 60, thereby enabling two-way communication between that internal telephone 60 and the ID card holder 10, causing a call signal to be emitted back to the private branch exchange 50 based on the received call signal. This enables the private branch exchange 50 to specify the internal telephone 60 that is being used by Mr A having the paged ID number, and the internal telephone 60 then connects the internal telephone 60 to the outside line, allowing Mr A to talk with the outside caller.

Thus, within the local paging transmission range (within a building or the like), this local-area paging system makes it easy for anyone to take an outside (or inside) call by using a nearby phone. When the ID card holder 10 is applied to such a paging system, after frequent use the battery 13 will run and need to be recharged. When an employee leaves the office, he leaves his ID card holder 10 in the ID card box 80 located near the exit. So if a recharging function is incorporated into the ID card box 80, the ID card holder 10 can be recharged overnight and be ready for use the next day.

If employees leaving the office place their ID card holder 10 into the box 80 with the ID card 20 still inside and retrieve the holder and card when they next come to the office, a computer can be used to keep track of employees' working hours based on the times the holder and card are placed in the box and retrieved. The computer can be connected to the private branch exchange 50 to which the box 80 transmits the IDs of the ID cards 3 in the box 5, to make it possible to centralize management of ID card usage and employee work hours.

In the above system paging signals are transmitted in one direction, which is from the local-area paging station 70 to the ID card holder 10, so the private branch exchange 50 cannot establish whether the ID number user being paged is inside or outside the system area. If a configuration is implemented that provides two-way communication between exchange and ID card holder (by giving the ID card holder the ability to transmit over the same distance as a base-station), the ID card holder can transmit a page-received signal to a base-station when the local ID is paged by an outside call, making it possible for the private branch exchange 50 to determine that the owner of the ID number being paged is within the system area, and to perform an appropriate action, such as sending a message to the outside line.

Instead of increasing complexity of the paging system by adding the ability to automatically connect to outside lines and the like, a simpler system can be used in a factory or other such site by using it to page just specific work personnel. For example, personnel who are always assigned to various tasks (cleaning, maintenance, security, building management, for example) and do not have their own internal telephone can be given ID card holders in which the wireless controller 12 is configured to only receive paging signals from a paging station. This would allow such personnel to be paged when their precise location is not known such as when they are on their rounds in factories and other such relatively large facilities.

Thus, with respect to outside or inside communications via the private branch exchange, the above-described local-area communication system of the present invention ensures both long-range wireless communication between local-area wireless base-stations and portable card terminals, and short-range wireless communication with an auxiliary telephone terminal in the vicinity of a user carrying a portable card terminal, enabling a user to utilize an auxiliary telephone terminal as if it was just his phone. That is, the portability of the card terminals has been enhanced by not including telephonic conversation capabilities, and as long as there is an auxiliary telephone terminal near at hand while a user is on the move, he can receive his calls. This makes the system very convenient for its users. Moreover, since the auxiliary telephone terminals are not connected to the private branch exchange, they can be readily located where they are needed. If a room does have an auxiliary telephone terminal, one can be brought from another room, giving the system a high degree of flexibility that greatly enhances its practical value.

Also, when a portable card terminal is not being used, it is placed in a special receptacle or box that automatically recharges the terminal's battery and transmits the card's ID number to the private branch exchange, which has the advantage of making it possible to maintain a practical recharging cycle by having users pick the terminals up when they come to work and return the terminals when they leave.

Moreover, the private branch exchange can cancel an incoming call that is made to a portable card terminal that is not in use, eliminating fruitless paging of card terminals that are in the special card-terminal box. Also, the system can readily be arranged so that when a call is made to a card terminal that is not in use, the caller can be informed of that fact by the private branch exchange.

The portable card terminals contain specific ID numbers assigned to specific individuals, so the cards can be used as keys to gain entry to areas to which access is restricted to those having the requisite security level clearance. Also, by having users place their cards in the card-terminal box when leaving the workplace and pick the cards up when coming in to the workplace, information on the times involved provided by the box can be used to keep track of each person's work hours, enabling the portable card terminals to be used instead of time-cards.

The ID card holder of the invention reads ID information from the ID card that is a unique identifier within a specified group, and transmits this ID information as a local ID. So when a user inserts his ID card in the ID card holder, it functions as his exclusive wireless card terminal. This makes it applicable to various systems that need to use ID information in communications. In addition, the ID card holder is formed separately from the ID card which, for security reasons, cannot be easily re-issued, and functions as an ID wireless communication terminal by reading the stored ID information. The ID card holder itself can be manufactured as a general-purpose component, so it can be just replaced by a new one if it develops a communication malfunction or other such problem.

The ID card holder can also be applied to a door locking system that controls access to a particular room or area. If wireless transmission capability is added to the ID card, its convenience is enhanced by enabling the ID information to be transmitted without the user having to bring the ID card into contact with the sensor section of the door lock system for the ID information to be read. If the ID card holder is applied to a local-area paging system, ID information read from an ID card worn by a user can be used to generate a determination that a call has been received that is specifically for that ID, and when an ID-information-based paging call is received from a wireless base-station of the local-area paging system, the person using the ID card holder can be notified that the local ID is being paged, making it possible to page a person who is in paging range but whose location is not known.

If the ID card holder is provided with transmission means having the same range as the wireless base-stations, the ID card holder can transmit a page-received signal to a base-station when the local ID is paged by an outside call, making it possible for the private branch exchange to determine that the holder of an ID number being paged is inside or outside the system area, and to perform an appropriate action. When an outside call to the local ID is received from a local-area paging system wireless base-station, the ID card holder can use an internal telephone within the communication area to connect back to the outside line by based on the outside call-received page. Anyone can therefore take an outside call be using a nearby internal phone.

What is claimed is:

1. A local-area communication system, comprising:
a private branch exchange that controls links between outside lines and a local area;
a plurality of wireless base-stations located within the local area, each base station having a wired connection to the private branch exchange;
a portable card terminal capable of wireless long-range communication with the wireless base-stations, said portable card terminal having stored therein a unique ID number and being capable of short-range wireless communication in the local area and being of a size that is suitable for carrying;
a plurality of auxiliary telephone terminals located within the local area capable of short-range wireless communication with the portable card is terminal and having a speech transmission function and a speech reception function; and
a portable card terminal holding means having a wired connection to the private branch exchange, the card holding means being able to recharge a portable card terminal accommodated therein and to transmit the ID number of the portable card terminal accommodated therein to the private branch exchange.

2. A local-area communication system according to claim 1, wherein the private branch exchange includes a cancel function for cancelling a communication request to the portable card terminal when having received from the card terminal holding means an ID number transmission signifying that the portable card is in the card terminal holding means.

3. A local-area communication system according to claim 1, wherein the portable card terminal can also be used for managing security within the local area by storing, as the ID number, ID number information that can identify a user, and using short-range wireless communication to transmit the ID number of the portable card terminal.

4. A local-area communication system according to claim 2, wherein the portable card terminal can also be used for managing security within the local area by storing, as the ID number, ID number information that can identify a user, and using short-range wireless communication to transmit the ID number of the portable card terminal.

5. An ID card holder, comprising:
an ID card accommodation section that removably accommodates ID cards in each of which is stored in an electronically readable state ID information that constitutes unique identification information within a specific organization;
wireless communication control means that performs wireless communication based on the ID information read from the ID cards in the ID card accommodation section; and
electric power supply means that provides electric power to drive the wireless communication control means and for recharging.

6. An ID card holder according to claim 5, wherein the wireless communication control means transmits the ID information to a wireless base-station of an access door control system when it has received an ID request from said base-station.

7. An ID card holder according to claim 5, wherein the wireless communication control means can generate, based on the ID information read from an ID card, a determination that a call has been received, the determination being specifically for an ID number of the ID card, and when an ID-information-based paging call is received from a wireless base-station of a paging system in a local area, can notify that a paging call to a user's ID number has been received.

8. An ID card holder according to claim 6, wherein the wireless communication control means can generate, based on the ID information read from an ID card, a determination that a call has been received, the determination being specifically for an ID number of the ID card, and when an ID-information-based paging call is received from a wireless base-station of a paging system in a local area, can notify that a paging call to a user's ID number has been received.

9. An ID card holder according to claim 7, wherein the wireless communication control means can transmit signals over a same distance as the wireless base-stations of the paging system in the local area and, when a paging call to a user's ID number is received, transmits a page-received signal.

10. An ID card holder according to claim 8, wherein the wireless communication control means can transmit signals over a same distance as the wireless base-stations of the paging system in the local area and, when a paging call to a user's ID number is received, transmits a page-received signal.

11. An ID card holder according to claim 7, wherein the wireless communication control means can perform short-range communication with internal telephone sets located within the local area and, when an outside call to a user's ID number is received from a wireless base-station, can connect an internal telephone set within a communication area to an outside line used to make the call by performing a reverse call based on the outside call.

12. An ID card holder according to claim 8, wherein the wireless communication control means can perform short-range communication with internal telephone sets located within the local area and, when an outside call to a user's ID number is received from a wireless base-station, can connect an internal telephone set within a communication area to an outside line used to make the call by performing a reverse call based on the outside call.

13. An ID card holder according to claim 9, wherein the wireless communication control means can perform short-range communication with internal telephone sets located within the local area and, when an outside call to a user's ID number is received from a wireless base-station, can connect an internal telephone set within a communication area to an outside line used to make the call by performing a reverse call based on the outside call.

14. An ID card holder according to claim 10, wherein the wireless communication control means can perform short-range communication with internal telephone sets located within the local area and, when an outside call to a user's ID number is received from a wireless base-station, can connect an internal telephone set within a communication area to an outside line used to make the call by performing a reverse call based on the outside call.
